(19) United States
(12) Patent Application Publication
(10) Pub. No.: US 2009/0287590 A1
(43) Pub. Date: Nov. 19, 2009

(54) Multi-Supplier Transaction and Payment Programmed Processing System and Approach

(75) Inventor: Dean W. Hahn-Carlson, Lilydale, MN (US)

Correspondence Address: CRAWFORD MAUNU PLLC, 1150 NORTHLAND DRIVE, SUITE 100, ST. PAUL, MN, 55120, US

(73) Assignee: U.S. Bank National Association

(21) Appl. No.: 12/493,038

(22) Filed: Jun. 26, 2009

Related U.S. Application Data
(63) Continuation of application No. 11/316,324, filed on Dec. 22, 2005.
(60) Provisional application No. 60/639,999, filed on Dec. 29, 2004.
(60) Provisional application No. 60/639,998, filed on Dec. 29, 2004.

(51) Int. Cl. G06Q 20/00; G06Q 40/00; G06Q 10/00; G06Q 30/00

(52) U.S. Cl. 705/29; 705/44; 705/40; 705/30; 705/34; 705/38

(57) ABSTRACT

In an example embodiment, a computer-based contract-management approach processes transactions involving at least one supplier (i.e., seller or sellers) fulfilling one or more sub-components of the transaction. Each of the suppliers (e.g., as well as other transaction parties) reference the transaction when communicating transaction information such as invoices, regardless of which sub-component of the transaction the seller is involved with. The invoices are associated with the transaction using the transaction referenced in each invoice and each supplier is accordingly paid for its performance of the sub-component of the transaction with which it is involved. From a buyer's perspective, the transaction is processed in accordance with the sub-components associated with the at least one supplier. Per each supplier, the transaction is processed generally two-dimensionally (via buyer and via suppliers), thus generally isolating (where desirable) each supplier from the sub-components of the transaction for which it is not a participant.

### RELATED DOCUMENTS

This patent document is a continuation of U.S. patent application Ser. No. 11/316,324 and filed on Dec. 22, 2005, to which benefit is claimed under 35 U.S.C. § 120; via the aforesaid patent application, this patent document also claims priority under 35 U.S.C. §119 to U.S. Provisional Patent Application No. 60/639,999, entitled “Multi-party Transaction Processing System and Approach” and to U.S. Provisional Patent Application No. 60/639,998, entitled “Multi-supplier Transaction and Payment Programmed Processing System and Approach,” both of which were filed on Dec. 29, 2004.

### FIELD OF THE INVENTION

The present invention is directed to communications and data processing and, more specifically, to communications and data processing involving the processing of transactions involving multiple suppliers for a single transaction.

### BACKGROUND

Operational management of contractual and transactional interactions between buyers, sellers, financial institutions and others involved in the exchange of products and/or services for purposes of commerce have typically been labor and time intensive. Generally, the processes of managing transactions between business entities have been unduly burdensome and inefficient.

Many transactions involve a variety of parties interacting at different hierarchical levels and in connection with different aspects of the transactions. For example, transactions involving different facets of performance (e.g., the provision of products or services) that can be fulfilled by different entities often involve two or more suppliers. For instance, when a transaction involves the provision of a multitude of goods, the goods may be sourced from different suppliers under the guise of the same transaction. Similarly, a service-based transaction may involve the provision of different aspects of service under the same contract. Further, transactions involving the purchase of a product often involve the provision of a product as well as shipping services for delivering the product from a seller to a buyer. These transactions also may involve processing services and/or fees along the delivery route, such as customs clearance at port of export, import/export duty fees, and insurance during transit, the responsibility for which can change amongst the parties depending on where the goods are actually located at a point in time. Using the shipping example, for many shipping transactions (e.g., that are separate from the purchase of goods being shipped), there is often a shipper (the entity arranging for shipment of the goods), a carrier (the entity carrying the goods), a seller (the entity selling the goods), an insurer (the entity providing transit insurance to the shipper, the carrier and/or the buyer), and a buyer (the entity receiving the goods). In this regard, the shipment itself can be considered a single shipping portion of a more complex transaction beginning with an agreement between a buyer and a seller. In some instances, the seller acts as the shipper and arranges and pays for shipment of the goods separately from the buyer and with the cost of the shipment effectively built into the cost of the goods. In other shipping transactions, the seller arranges for shipment of the goods per the buyer's instructions and the buyer pays for the shipping services directly to the party selected by the seller.

In the above-discussed and other types of transactions, the seller sometimes performs by providing goods and/or services directly and, at other times, the seller contracts with a performing party to perform some or all of the transaction aspects. In this instance, the seller acts as an intermediary, with the buyer agreeing to pay an amount contracted between the intermediary seller and the buyer. The seller in turn agrees to pay the performing parties (e.g., subcontractors) an amount contracted between the seller and each performing party.

In each of the above examples, various invoices and related activities (accounting, adjustments, etc.) are required for each contract in the chain of contracts between buying, selling, intermediary or performing parties. In addition, tracking activities for commercial and regulatory purposes often require that records be kept for the transaction. These activities are time consuming, subject to error and often duplicative in nature. For example, at the payment step, financial institutions for different parties to the transaction must interact with each other. This interaction typically involves complex agreements and associations that facilitate the transfer of funds. At times, there can be delays in payment or disputes regarding terms of payment. In addition, this process is highly susceptible to error. Interaction complexity, delay, error and a multitude of other characteristics of transaction payment can cost one or more parties to a transaction (including financial institutions) a significant amount of funds.

Most industries are quite competitive and any cost savings are therefore important. Administrative costs are targeted for reduction as no revenue is directly generated from administrative functions. However, administrative costs associated with commercial transactions have been difficult to reduce in the current business environment with widely diffused data.

The above and other difficulties in the management and coordination of business transactions have presented administrative and cost challenges to business entities involved in various aspects of transactions, including financial institutions and others.

### SUMMARY

The present invention is directed to addressing challenges related to the types of applications discussed above and others. The present invention is exemplified in a number of implementations and applications, some of which are summarized below.

According to an example embodiment of the present invention, a transaction is automatically processed to effect payment to at least one supplier for the transaction as a function of portions of the transaction fulfilled by each supplier. In one implementation, transaction documents (e.g., electronic data) are audited and the payment is effected as a function of the audit. In another implementation, a fee is assessed to one or more parties to the transaction as a function of the transaction and an agreement with the one or more parties to the transaction.

In another example embodiment, shipping transactions involving two or more carriers fulfilling different portions (legs) of a shipping route are processed as a function of information received for each carrier and common transaction identification information. Each of the carriers submits an invoice and the invoices are correlated to a particular transaction. Payment is facilitated (e.g., authorized) as a function of the invoices.

According to another example embodiment of the present invention, an automated transaction processing system is adapted for facilitating transaction processing for a transaction involving two or more suppliers. Contract data is stored for parties to a transaction. The contract data includes a transaction identification (ID) and information relating to a contract involving the exchange of merchant offerings (i.e., goods and/or services) between a buyer party and at least two supplier parties, where each supplier fulfills a sub-part of the contract either at the direction of the buyer or at the direction of a third party. Payment request information including a transaction ID from the supplier parties is sent to the automated transaction processing system. The payment request information (e.g., an invoice with a transaction ID) typically reflects payment characteristics of the transaction that are related to the merchant offerings provided by the supplier party providing the payment request information. The payment request information from each supplier party is audited as a function of a comparison of the transaction ID in the payment request information with the stored transaction ID in the contract data. When the transaction ID in the payment request information from a particular supplier party matches the transaction ID in the contract data, settlement of a sub-part of the contract involving merchant offerings provided by the particular supplier party is effected as a function of the payment request information from the particular supplier party and the sub-part of the contract.

The above summary of the present invention is not intended to describe each illustrated embodiment or every implementation of the present invention. The figures and detailed description that follow more particularly exemplify these embodiments.

### BRIEF DESCRIPTION OF THE DRAWINGS

The invention may be more completely understood in consideration of the detailed description of various embodiments of the invention in connection with the accompanying drawings, in which:

FIG. 1 shows a transaction processing arrangement and approach, according to an example embodiment of the present invention;

FIG. 2 shows an arrangement and approach for managing shipping-related transactions, according to another example embodiment of the present invention; and

FIG. 3 shows a flow diagram for transaction processing, according to another example embodiment of the present invention.

While the invention is amenable to various modifications and alternative forms, specifics thereof have been shown by way of example in the drawings and will be described in detail. It should be understood, however, that the intention is not necessarily to limit the invention to the particular embodiments described. On the contrary, the intention is to cover all modifications, equivalents, and alternatives falling within the spirit and scope of the invention as defined by the appended claims.

### DETAILED DESCRIPTION

The present invention is believed to be applicable to a variety of different types of communications and financial process management approaches, and has been found to be particularly useful for applications involving the implementation and application of payment-related transaction processes and related aspects thereof. While the present invention is not necessarily limited to such approaches, various aspects of the invention may be appreciated through a discussion of various examples using these and other contexts.

According to an example embodiment of the present invention, a transaction involving multiple suppliers is automatically processed using contractual (transaction-related) terms for each of the suppliers and one or more buying parties. Each of the suppliers fulfills a particular portion of the transaction, with the one or more buying parties receiving merchant offerings (e.g., goods and/or services) provided by the suppliers in accordance with terms of the transaction. When billing data (e.g., an invoice) is received from one of the suppliers, the data is automatically related to the particular transaction using information in the billing data together with stored information for the transaction. Funds from a buying party (or buying parties, where appropriate) are passed to the supplier as indicated in the contractual terms and in accordance with the billing data. Billing data submitted by subsequent suppliers is processed similarly. In this regard, each supplier is part of a common transaction and is paid according to the portion of the transaction fulfilled by the supplier. This approach is applicable to direct buyer-seller type relationships as well as to other relationships, such as those involving the buyer as an intermediary buyer/seller type party, subcontracting with suppliers to carry out conditions of a particular transaction.

In some applications, one or more suppliers to a transaction are generally isolated from information regarding the transaction that is not directly related to the particular supplier or suppliers. That is, transaction information associated with the supplier is separately processed and/or managed such that the supplier's view of the transaction is generally limited to portions of the transaction in which the supplier is specifically involved. In some instances, the supplier is limited in view of the transaction to contract-type functions, such as between the supplier and a buyer or intermediary buyer, and/or payment type functions, such as between the supplier and a financial institution providing payment for the transaction. In this regard, from each supplier's perspective, the “transaction” is limited to that involving the supplier, while from a buyer's (or intermediary's) perspective, the transaction involves multiple suppliers and/or separate sub-transactions that make up the whole transaction.

In one implementation, a fee is assessed to at least one party to the transaction as a function of one or more of a variety of transaction characteristics. In some applications, a host party (e.g., a supplier) is assessed a fee as a function of a payment amount for the transaction as characterized by a fee contract between the host party and an entity facilitating the transaction processing. In other applications, multiple parties are assessed fees in accordance with similar fee contracts and/or a transaction payment amount. These fees are further assessed, where appropriate, in a manner commensurate with sub-parts of the transaction (and related contract) performed by different suppliers.

Another example embodiment involves the electronic delivery of information. For example, streaming marketing information could be provided by multiple suppliers for a common transaction. As another example, telephone voice data can be delivered by two or more information carriers. These electronic delivery applications may involve, for example, the use of the Internet, telephone lines and/or transmission towers. Where streaming data is provided via the Internet, electronic data carriers may pick up data for delivery from one or more supplier source terminals to one or more destination terminals. In some applications, preloaded, password-secured profiles with profile data are used to launch the delivery of the electronic (e.g., streaming) data and/or the implementation of the data at a destination terminal.

In another example embodiment, a shipping transaction involving multiple carriers is processed using a unique order identification (ID) for different routes served by different carriers. The unique order ID is referenced to origin and destination locations for shipping an item over a primary route, with separate carriers performing portions of the route along which the item is shipped. Shipping invoices from the carriers are automatically associated with the primary route using information in the invoices. Further, the shipping invoices are separately associated with the portion of the route serviced by the particular carrier that is the subject of the invoice. This information is used to audit the invoices and to generate a payment authorization based upon the invoice (and, in some instances, effect the payment). Each carrier is paid according to its portion of the primary route. In some implementations, business rules and/or other information relating to the parties to the transaction (e.g., profile information) is stored and used for associating and/or auditing transaction data such as invoices. For general information regarding shipping transactions and for specific information regarding shipping transaction approaches that can be implemented in connection with this and/or other example embodiments herein, reference may be made to U.S. Pat. No. 5,910,896, which is fully incorporated herein by reference.

In another implementation, a pay-through-payment approach is used for paying sub-suppliers from buying parties while limiting the transaction, from a particular sub-supplier's perspective, to that arranged between the particular sub-supplier and an intermediary buying party. For instance, where a buying party is an intermediary and a product or service of the transaction is targeted to an outside buyer, payment for transaction performance by each respective supplier is processed directly from the outside buyer to the supplier as part of the processing of payment from the outside buyer to the intermediary supplier/buyer. However, transaction information for each sub-supplier is separately processed in accordance with terms associated with an individual transaction between the sub-supplier and the intermediary, with payment being separately processed (and made) by the intermediary and sourced from the outside buyer. In this regard, from a supplier's perspective, its portion of the transaction is limited to that between the supplier and the intermediary buyer, with payment coming from an outside source but made according to the transaction between the supplier and the intermediary. For general information regarding transaction processing and for specific information regarding pay-through-payment type approaches that can be implemented in connection with this and other example embodiments herein, reference may be made to U.S. patent application Ser. No. 11/316,381 filed on Dec. 22, 2005 and entitled: “Multi-Party Transaction Processing System and Approach” (Attorney Docket No. USBA.133PA), which is fully incorporated herein by reference.

In some implementations, an auditing process is carried out in connection with the receipt of the billing data discussed above. For instance, when billing data includes a seller's identification information (ID) associated with a particular identifiable transaction, the billing data is audited to ensure that the particular seller is indeed party to the identifiable transaction. Furthermore, terms of the billing data such as payment amount and/or other associated fees, timing (payment and/or contract performance) and others are selectively audited to ensure that certain transaction-based conditions are met.

In another example embodiment, business rules for buying and/or selling parties are used to process the transaction and further, where applicable, to control access to information relating to the transaction. For instance, where a buyer (or intermediary buying party) contracts with different sellers, business rules for the buyer are used in processing the transaction. These rules may include, for example, rules for setting contract terms, making payment or providing information to seller parties. In addition, the business rules can be tailored to specific transactions, with certain transaction terms set for the specific transaction.

In some implementations, the business rules include information for differentiating between suppliers for applying particular rules. That is, a particular transaction involving two different suppliers is processed according to different business rules. Portions of the transaction relating to a particular seller are processed in accordance with business rules for that particular seller, with other portions of the transaction involving other sellers being processed according to business rules for each particular seller, where applicable. For instance, a buyer and seller may agree upon specific business transaction terms, such as payment time, payment type, shipping fees and more. These specific business transaction terms can be separately recorded in association with business rules that apply to a particular seller.

In one implementation, business rules are selectively applied to a particular seller according to characteristics related to the seller and/or the transaction; different sets of business rules may apply to a particular seller. For example, transaction characteristics such as geographic location, location of the particular transaction with the seller (or of a substantial portion of the transaction with the seller) or associations between the seller and other entities may benefit form the selective application of business rules.

A variety of transaction processing functions, including those discussed above, can be carried out implementing business rules for purposes including the association of transaction data, selection of contract terms, management of contract payment and/or auditing functions and more. For general information regarding contracts and transaction processing, and for specific information regarding contract and transaction processing approaches to which the present invention may be applicable, reference may be made to U.S. patent application Ser. No. 10/436,878 (USBA.101PA), filed May 12, 2003 and fully incorporated herein by reference.

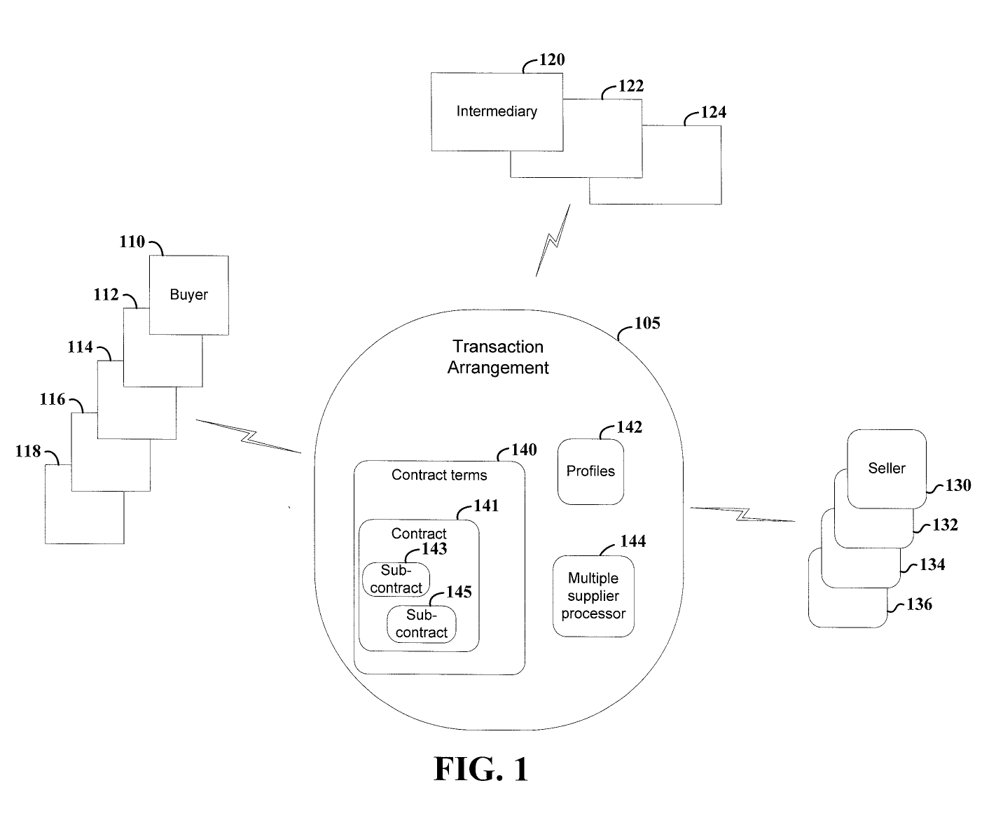

Turning now to the figures, FIG. 1 shows a transaction processing arrangement and approach, according to another example embodiment of the present invention. A transaction arrangement 105 manages transactions between buying parties and two or more parties that facilitate the provision of goods and/or services (e.g., merchant offerings) in accordance with a particular transaction for which payment is to be made (e.g., via interaction with one or more financial institutions). Here, a plurality of transaction parties including buyer parties 110-118, intermediary parties 120-124 and selling parties 130-136 are shown by way of example. While certain buying, intermediary and selling parties are shown, this example embodiment and related approaches are applicable to a multitude of such parties, as well as to additional types of transactional parties (or fewer parties, e.g., with no intermediary party and/or a single buyer with two sellers), which may be implemented for a variety of situations.

The transaction arrangement 105 stores data (locally and/or remotely) relating to contract terms 140 and user profiles 142, and further processes transaction functions using a multiple supplier processor 144. The contract terms 140 include information for specific contracts related to transactions processed by the transaction arrangement 105. The contract terms 140 can govern a single transaction, such as in a spot bid/award situation, or multiple transactions, such as a multi-year contract for timed deliveries of particular goods. By way of example, one contract 141 is shown stored with the contract terms 140 and includes sub-contracts 143 and 145 for different sellers for a common transaction.

The user profiles 142 include information about parties to each transaction, such as financial account information that facilitates the execution of payment functions for the transaction, or information such as passwords facilitating access control to transaction information. The multiple supplier processor 144 is programmed for processing transaction related data such as order confirmation, shipping confirmation, payment authorization and settlement details for facilitating the transaction and payment-related aspects thereof.

The contract terms 140 describe information for particular contracts between a buyer or buyers and two or more sellers, with each seller performing a portion of the transaction. These contract terms 140 may, for example, include contract terms specific to a particular seller and/or to a particular transaction, where contract terms may or may not vary between different sellers, depending upon the application. For instance, when buyer 110 has a separate contract with sellers 130 and 132 for a single transaction, the multiple supplier processor 144 implements specific contract information related to the particular seller for which the portion of the transaction is being processed. That is, when processing transaction functions such as payment for a particular transaction involving the buyer 110 and sellers 130 and 132, the multiple supplier processor 144 uses different contract terms when processing portions of the same transaction but involving a different selling party. When the contract terms 140 include contract terms that are consistent among different sellers for a particular transaction, these terms are implemented consistently (relative, e.g., to the separately implemented terms discussed above).

In some applications involving intermediary parties (120-124), the transaction arrangement 105 processes the transactions supplied by two or more of the sellers 130-136 and received (goods and/or services) by one or more buyers 110-118. For example, where an intermediary party 120 executes a transaction with a buyer 110 for shipping goods along a particular main shipping route, the intermediary party may contract separately with two or more sellers (carriers) 130 and 132. Here, the buyer 110 may be the recipient of goods being shipped or the provider of goods that will be shipped to a customer. The transaction is related to a particular service, namely, the shipping of goods over the particular main shipping route (from an origin to a destination) as indicated by the buyer or other entity, and the transaction is accordingly referenced as such. However, each seller (carrier) performs shipping functions over separate sub-routes that make up the route between the origin and the destination, from the origin to an intermediate location and, subsequently, from that intermediate location to the destination. The transaction arrangement 105 processes, with the multiple supplier processor 144, transaction information relating to payment for each of the sellers (carriers) 130 and 132 for their respective services performed with each sub-route by reference to the main shipping route.

The multiple supplier processor 144 carries out payment and other interactive type functions with buyers, sellers and, where applicable, intermediaries in a variety of manners, depending upon the contract terms 140 and profiles 142. For instance, a particular contract between a buyer 110 and a seller 130 may indicate when payment is to be effected. In some applications, payment to the seller 130 is effected upon completion of the seller's portion of the transaction (e.g., in the above example, when a seller (carrier) performs its portion of the shipment route). In other applications, payment to the seller 130 is effected upon completion of the entire transaction (e.g., in the above example, when the shipment reaches its destination). A multitude of types of terms such as these are implemented with the contract terms 140 and processed by the multiple supplier processor 144, depending upon the application and particular contracts between parties to the transactions.

In another embodiment, the multiple supplier processor 144 facilitates processing for transactions involving a contract that is fulfilled over time. For example, where a buyer 110 enters into a contract with an intermediary party 120 for merchant offerings over a particular time period, the multiple supplier processor 144 processes payment functions for sub-parts of the contract as they are fulfilled over time by different suppliers (e.g., using a common transaction ID). This approach can be implemented, for example, when the intermediary party 120 contracts with the buyer 110 for providing a particular bundle of goods at intervals. The intermediary party 120 may then contract with suppliers 130 and 132 for providing the bundle of goods at different times. In this regard, the multiple supplier processor 144 processes invoice information received from the suppliers 130 and 132 submitted, e.g., as they respectively fulfill the sub-parts of the contract.

In another example embodiment, an intermediary party 120 operates the transaction arrangement 105 for processing transactions between buyers 110-118 and sellers 130-136 according to contract terms 140 supplied by the transaction parties and further assessing a processing fee to one or more of the transaction parties. For example, where a buyer 110 contracts with two sellers 130 and 132 for respectively filling sub-components of a transaction, the buyer may enlist the services of the transaction arrangement 105 for processing financial aspects of the transaction. The multiple supplier processor 144 processes transaction information, such as invoices received from the sellers 130 and 132, by associating the invoices with a particular transaction and further with the particular seller providing the invoice. The association is used to determine elements of the contract terms 140 to use in processing (e.g., auditing) the invoices and correspondingly effecting payment therefore. The payment authorization is matched to a particular transaction at block 310. The matching may involve using, for example, transaction-identifying or party-identifying information in the payment authorization.

Fees are assessed according to one or more of a variety of characteristics, such as the financial aspects of the transaction (e.g., the amount of a sale processed by the transaction arrangement 105) or a set fee. These fees may, for example, be set as a function of a contract between the intermediary party 120 and parties (buyers or sellers) to the transaction.

In another example embodiment, the transaction arrangement 105 is adapted for processing financial transactions involving two or more financial suppliers (i.e., fund suppliers) providing funds to a buyer, seller or other appropriate party participating in a particular transaction. Each of the financial suppliers provides sub-parts of a fund amount to the buyer or seller to fund classes of transactions that meet defined parameters (e.g., specific goods procured by defined buyers from defined sellers). Payment type data, such as a fee assessed for providing funds for a sub-part to the financial transaction, provided by each financial supplier is processed by the multiple supplier processor 144 using a common transaction ID. This approach can be implemented, for example, where a buyer uses multiple financiers to provide funds for particular transactions meeting defined funding parameters, implementing separate contract terms 140 for financial services provided by each financier.

In one implementation, two or more financial suppliers provide funds in different currencies for a particular financial transaction. The transaction arrangement 105 processes sub-parts of a transaction for each currency as provided by different financial suppliers (e.g., wherein a first supplier provides funds in a first currency and a second supplier provides funds in a second currency, for use in a common transaction). Each financial supplier references a common transaction ID when providing payment type data to the transaction arrangement 105. One example application to which this implementation may be applied involves a buyer in a first country purchasing goods and/or services from a seller in a second country. A first financial supplier provides funds in a first currency on behalf of the buyer and accordingly assesses a fee (e.g., in the amount of the provided funds plus a service and/or financing charge). A second financial supplier provides funds in a second currency on behalf of the seller and assesses a fee (e.g., in a converted amount of the provided funds in the second currency plus a service and/or financing charge). In certain related applications, a second financial supplier considers the identity of the buyer and the first financial supplier when making its decision as to whether to provide funds to the supplier (e.g., in pre-export financing situations or in post-export, pre-ownership assumption situations). Rules or other characteristics related to the transaction and/or transaction parties may thus contemplate the second financial supplier's consideration of one or more of the identity of the buyer and the first financial supplier. In all these implementations, the fees are selectively assessed to the buyer and/or to a party to a transaction for which funds in the financial transaction are being provided.

The association approach described above may be implemented using, for example, one or more of the embodiments and implementations described in connection with U.S. patent application Ser. No. 10/864,761 (USBA.120PA), filed Jun. 9, 2004, which is fully incorporated herein by reference. Furthermore, other transaction processing approaches discussed herein may implement such association approaches in the processing of multiple-supplier type transactions that involve sub-transaction components associated with a particular main transaction and the according processing thereof.

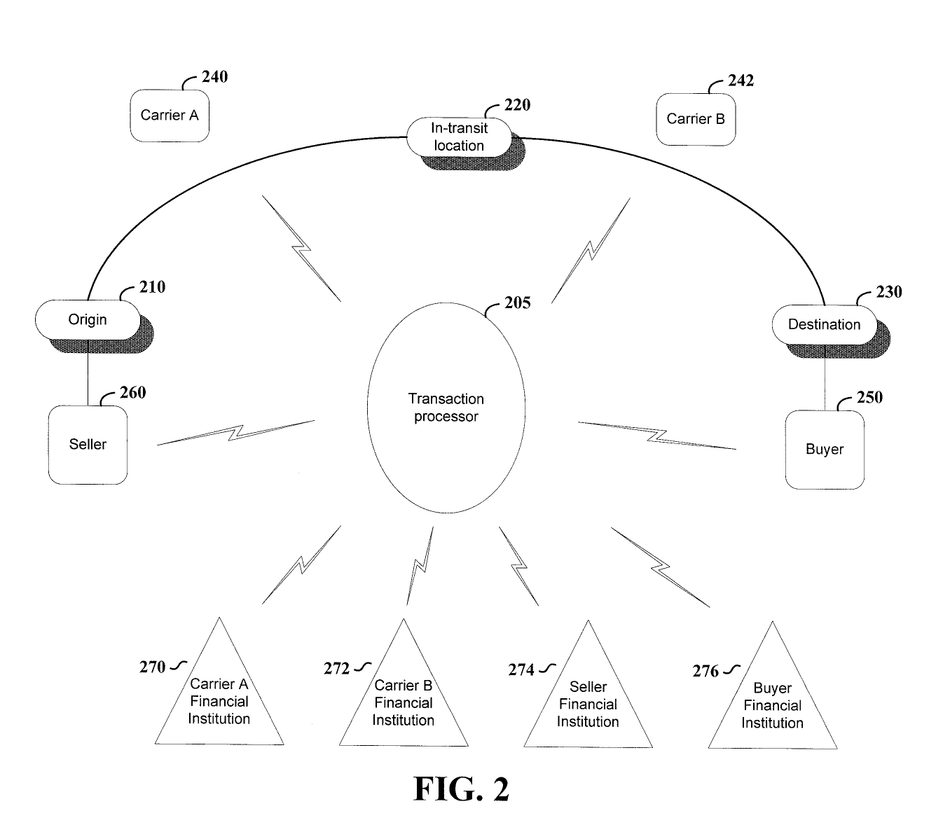

FIG. 2 shows an arrangement and approach for managing shipping-related transactions via a transaction processor 205, according to another example embodiment of the present invention. The approach shown in FIG. 2 can be implemented in connection with transaction processing approaches as described, for example, in connection with FIG. 1 above. The approach shown in FIG. 2 involves processing a shipment transaction between an origin 210 and a destination 230, with a seller 260 providing an item to be shipped at the origin to a buyer 250 purchasing the item and receiving the item at the destination 230. In some instances, a third party buyer receives the item at the destination 230 where, e.g., the buyer 250 may in turn invoice the third party buyer for the item.

Carrier A (240) ships the item from the origin 210 to an in-transit location 220 and carrier B (242) ships the item from the in-transit location to the destination 230. In this regard, the total shipping route, between the origin 210 and the destination 230 is served by two sub-routes with the in-transit location 220. Each carrier 240 and 242 references the sub-component of the shipping route it performs by simply referring to an overall transaction ID that is common to the entire shipping transaction, regardless of which portion of the transaction is involved.

The transaction processor 205 facilitates the processing of contractual and payment functions of the transaction involving the shipment from the origin 210 to the destination 230. In this regard, the transaction processor 205 is in communication with each party to the transaction as described above, electronically or otherwise, as well as to financial institutions for the parties to the transaction, with example institutions 270-275 respectively serving carrier A, carrier B, the seller and the buyer.

In one example, the transaction processor 205 processes a shipping transaction as follows, using a transaction ID to reference portions of the transaction fulfilled by the different carriers. A seller or transaction management entity provides transaction information to the transaction processor for use in identifying invoices and other data received in connection with the transaction. This information includes contract information, transaction party profile information (e.g., identification and financial institution) and more.

When carrier A (240) performs its portion of the transaction, it submits an invoice to the transaction processor 205, the invoice referencing the common transaction ID. Similarly, when carrier B (242) performs its portion of the transaction, it submits an invoice to the transaction processor 205, also referencing the same transaction ID. The transaction processor takes the invoice information and facilitates payment as a function of the contract information by matching information in the invoice with the transaction (e.g., using the common transaction ID with the source of the invoice). For example, where the contract information indicates that carrier A is not to be paid until receipt of the shipped items at the in-transit location 220, such receipt is used to authorize payment processing at the transaction processor. Alternately, the contract information may indicate that carrier A is not to be paid until receipt of the shipped items at the destination 230. The invoice for carrier B may be similarly processed. Other contractual characteristics, such as payment date, acceptance of items shipped and more, where applicable, are further implemented by the transaction processor 205 in generating an authorization for payment of an invoice.

When payment for an invoice is authorized successfully, the transaction processor 205 further facilitates payment by communicating with one or more of the financial institutions 270-276 such that the carriers are paid for the services they provide, from the buyer 250 and/or the seller 260, depending upon the particular transaction and contract terms. Funds for the carriers are provided from the buyer 250 and/or from the seller 260, depending upon the application. For instance, where the seller 260 is a shipper contracting with the buyer 250 for shipment of the items, the seller would generally invoice the buyer directly for an agreed-upon transaction fee. In turn, the seller would be invoiced by the carriers for their portion of the transaction fee. In this instance, where indicated by contract terms available to the transaction processor 205, the seller 260 may provide funds via the seller financial institution 274 to each of the carrier financial institutions 270 and 272. Payment for the overall transaction is made to the seller financial institution 274 via the buyer financial institution 276 (e.g., separately from payment to the carriers). In some applications, the seller 260 directs the transaction processor to pay each carrier financial institution (270, 272) from funds provided by the buyer 250 via the buyer financial institution 276 directly to each carrier financial institution. The remaining funds (if any) available from the buyer 250 are then provided to the seller.

In other instances, the buyer 250 contracts separately with the carriers 240 and 242 for shipping the items and further accordingly makes funds available via the buyer financial institution 276 for payment upon approval of invoices submitted by the respective carriers. In these instances, the transaction processor 205 would implement contract terms between the buyer 250 and carriers 240 and 242 for facilitating the payment, with a common transaction ID representing the entire shipment route from the origin 210 to the destination 230 being implemented for associating the invoices with the transaction.

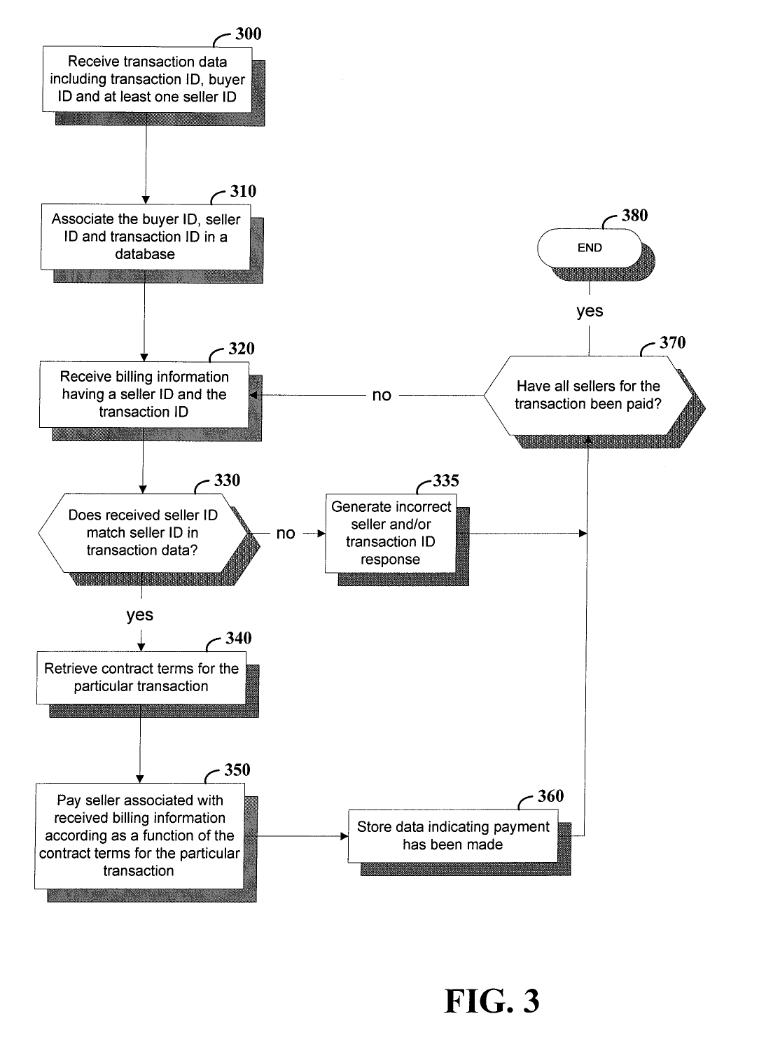

FIG. 3 shows a flow diagram for transaction processing, according to another example embodiment of the present invention. The approaches described in connection with the flow diagram in FIG. 3 can be implemented using one or more types of transaction arrangements and may, for example, involve the use of one or more of the arrangements or components thereof as shown in FIGS. 1 and/or 2 and described in connection therewith. At block 300, transaction data including a transaction identification (ID), buyer ID and at least one seller ID is received, e.g., at a transaction processing location/arrangement. The buyer ID, seller ID and transaction ID are associated in a database, linking the buyer and seller IDs with the transaction to which the transaction ID is assigned.

At block 320, billing information for a portion of the transaction fulfilled by a seller is received with that seller's ID and the transaction ID. The billing information is communicated using, for example, an electronic invoice sent via a communications network to a transaction processing node on the communications network. If the seller ID does not match a seller ID associated with the transaction to which the transaction ID is assigned at block 330, an incorrect seller and/or transaction ID response is generated at block 335. The incorrect seller and/or transaction ID response may include, for example, one or more of notifying the seller providing the billing information that the match failed, notifying a buyer in the transaction that the match failed or resolving the issue. A mismatched seller ID can be resolved, e.g., by comparison of the received seller ID with known seller IDs for the transaction and associating the received seller ID with a known seller ID using a typographic-tolerance or other approach.

If the seller ID matches a seller ID associated with the transaction data (i.e., with the transaction ID) at block 330, contract terms for the particular transaction associated with the transaction ID are retrieved at block 340. At block 350, the seller associated with the seller ID is paid as a function of the contract terms for the particular transaction associated with the transaction ID. This approach at blocks 340 and 350 may involve, for example, retrieving contract terms from a database, stored under the transaction ID, and authorizing or otherwise facilitating payment for the transaction based upon the contract terms and the received billing information. In some instances, the billing information is audited at block 350 as part of the payment process, with payment authorized or facilitated as a function of the auditing (i.e., when the billing information is consistent with and/or within range of expected or acceptable billing information, payment is authorized).

After the seller has been paid at block 350, payment data indicating the payment for the transaction in accordance with the billing information is stored at block 360. In some instances, this payment data is stored with the received billing information. After the payment data has been stored at block 360, or after an incorrect seller and/or transaction ID response is generated at block 335, stored payment data is parsed to determine, at block 370, whether all sellers for the transaction have been paid. If all sellers for a particular transaction have indeed been paid, the process stops at block 380. If all sellers for a particular transaction have not been paid, the process continues at block 320 when additional sellers submit billing information.

While certain aspects of the present invention have been described with reference to several particular example embodiments, those skilled in the art will recognize that many changes may be made thereto without departing from the spirit and scope of the present invention, aspects of which are set forth in the following claims.

What is claimed is:

1. An automated transaction system comprising:
a data storage arrangement that stores:
data identifying profiled parties including buyers and sellers; data for identifying contract-defined transactions between each buyer and at least two sellers that fulfill respective sub-parts of the transaction; contract-defined terms for the contract-defined transactions; and sets of business rule variables and transaction processing rule variables respectively defined on behalf of the profiled parties, and
cross-correlation data for correlating each contract-defined transaction with data identifying profiled parties for the transaction;
a correlation engine configured to respond to order and payment request data sets by accessing the correlation database to identify a contract-defined transaction related to the order and payment request data, and to correlate, with the transaction, data identifying profiled parties and sets of business rule and transaction processing rule variables for the correlated parties;
an automatic transaction processing engine configured, for each sub-part of each transaction, to execute an audit algorithm, using the correlated variables and contract-defined terms for the correlated contract as inputs, to audit a payment request data set for the sub-part of the transaction against the received order data to determine a condition of payment authorization for the payment request data set; and
a payment engine configured to respond to the determined condition of payment authorization indicating that payment for an audited payment request data set is appropriate by using the correlated variables and contract-defined terms for the correlated contract to determine a payment amount, and generate and output an electronic payment instruction, based upon the correlated business rule variables and the determined payment amount, to effect payment to the seller.

2. The system of claim 1,
further including a transaction-tracking database configured to store historical status data for each contract-defined transaction,
wherein the automatic transaction processing engine is configured to execute the audit algorithm by using the stored status data an additional input to the algorithm to audit the payment request data set according to the historical data to determine a condition of payment authorization that is relevant to an historical-based credit worthiness for extending payment for the sub-part of the transaction.

3. The system of claim 1, wherein
the correlation engine is configured to
respond to order data received from a buyer, the order data specifying a transaction ID, quantities of merchant offerings, and a monetary amount for the merchant offerings, by correlating the received order data with a particular contract and with variables defined for the buyer using the cross-correlation data, and
respond to respective sets of payment request data received from supplier parties, each payment request data set including a transaction ID and payment data related to the merchant offerings provided by the supplier party for the payment request data set, by correlating each set of received payment request data with a particular contract and with variables defined for the supplier using the cross-correlation data, and
the automatic transaction processing engine is configured to execute the algorithm for each set of payment request data corresponding to a particular sub-part of a transaction.

4. The system of claim 1, wherein the payment engine is configured to generate fee to assess a fee against at least one transaction party for the electronic payment as a function of at least one of: the payment request data set and the correlated contract-defined terms.

5. The system of claim 1, wherein the payment engine is configured to generate and output an electronic payment instruction to each seller performing a sub-part of a particular transaction to effect payment from the buyer to each seller.

6. The system of claim 1, wherein
the data storage arrangement stores contract-defined terms for a common transaction involving multiple merchant offerings and different sellers that fulfill sub-parts of the common transaction,
the correlation engine is configured to respond to payment request data sets from each of the different sellers by correlating the request data sets with the common contract-defined transaction, and
the automatic transaction processing engine is configured to execute an audit algorithm, for each payment request data set, to determine a condition of payment authorization of each data set.

7. An automated transaction system comprising:
a data storage arrangement that stores:
data identifying profiled parties including buyers and financiers that provide funds on behalf of the buyers; data for identifying contract-defined transactions between each buyer and at least two financiers that fulfill respective sub-parts of the transaction using a pool of funds provided by at least two financial suppliers each of the financial suppliers providing a portion of the pool of funds as specified in the stored contract data; contract-defined terms for the contract-defined transactions; and sets of business rule variables and transaction processing rule variables respectively defined on behalf of the profiled parties, and
cross-correlation data for correlating each contract-defined transaction with data identifying profiled parties for the transaction;
a correlation engine configured to respond to received event data by accessing the correlation database to identify a contract-defined transaction related to the event data, and to correlate, with the transaction, data identifying profiled parties and sets of business rule and transaction processing rule variables for the correlated parties;
an automatic transaction processing engine configured to, for each sub-part of each transaction and the portion of the pool of funds relating thereto, execute an audit algorithm, using the correlated variables and contract-defined terms for the correlated contract as inputs, to audit repayment for the sub-part of the transaction to determine a condition of payment authorization therefor; and
a payment engine configured to respond to the determined condition of payment authorization by using the correlated variables and contract-defined terms for the correlated contract to determine a payment amount, and generate and output an electronic payment instruction, based upon the correlated business rule variables and the determined payment amount, to effect payment to the financier providing funds for the sub-part of the transaction.

8. The system of claim 7, wherein the at least two financial suppliers for one of the transactions include financial suppliers that supply funds in different currencies, wherein the payment engine is configured to generate and output an electronic payment instruction for each sub-part in a currency specified in the correlated variables.

9. The system of claim 7, wherein
the stored business rule variables for the financiers include variables for specifying transaction criteria of transactions for which the financier will supply funds, and
the automatic transaction processing engine is configured execute the audit algorithm to audit a sub-part of a transaction between the buyer and a seller for which a specified financier is to provide payment, using the specified transaction criteria as inputs to the audit algorithm, to determine a condition of payment authorization by the financier.

10. A processor-implemented method for processing electronic transactions, the method comprising:
storing, in a data storage arrangement
data identifying profiled parties including buyers and sellers; data for identifying contract-defined transactions between each buyer and at least two sellers that fulfill respective sub-parts of the transaction; contract-defined terms for the contract-defined transactions; and sets of business rule variables and transaction processing rule variables respectively defined on behalf of the profiled parties, and
cross-correlation data for correlating each contract-defined transaction with data identifying profiled parties for the transaction;
operating a correlation engine module, in response to order and payment request data sets, to access the correlation database to identify a contract-defined transaction related to the order and payment request data, and to correlate, with the transaction, data identifying profiled parties and sets of business rule and transaction processing rule variables for the correlated parties;
operating an automatic transaction processing engine module to, for each sub-part of each transaction, execute an audit algorithm, using the correlated variables and contract-defined terms for the correlated contract as inputs, to audit a payment request data set for the sub-part of the transaction against the received order data to determine a condition of payment authorization for the payment request data set; and
operating a payment engine module to, in response to the determined condition of payment authorization indicating that payment for an audited payment request data set is appropriate, use the correlated variables and contract-defined terms for the correlated contract to determine a payment amount, and generate and output an electronic payment instruction, based upon the correlated business rule variables and the determined payment amount, to effect payment to the seller.
